(19) United States
(12) Patent Application Publication
(10) Pub. No.: US 2013/0204835 A1
(43) Pub. Date: Aug. 8, 2013

(54) METHOD OF EXTRACTING NAMED ENTITY

(71) Applicants: Cong-Lei Yao, Beijing (CN); Yuhong Xiong, Beijing (CN); Li-Wei Zheng, Beijing (CN)

(72) Inventors: Cong-Lei Yao, Beijing (CN); Yuhong Xiong, Beijing (CN); Li-Wei Zheng, Beijing (CN)

(73) Assignee: Hewlett-Packard Development Company, LP, Houston, TX (US)

(21) Appl. No.: 13/643,925

(22) PCT Filed: Apr. 27, 2010
(86) PCT No.: PCT/CN10/72235

§ 371 Date: Dec. 17, 2012

(51) Int. Cl. G06N 5/04

(52) U.S. Cl. CPC G06N 5/048
USPC 706/52

(57) ABSTRACT

Presented is a method of extracting named entities from a large-scale document corpus. The method includes identifying named entities in the corpus and forming a set of seed entities manually or automatically using some existing resources, constructing a named entity graph to discover same-type probability between any given pair of named entities, expanding the set of seed entities and performing a confidence propagation of the seed entities on the named entity graph.

### BACKGROUND

The advent of internet has resulted in an information explosion like never before. With thousands of documents getting uploaded each day, the net has become the favorite place to search for information. A named entity (NE) search is one of the mechanisms to search for right information. A named entity, generally, refers to a word or groups of words, such as, the name of a company, a person, a location, a time, a date, a numerical value, etc. A named entity search may make the task of looking for relevant information relatively easier. However, searching for a complex named entity, such as, a group of words, with multiple simple named entities is not small task, given the corpus of search documents could potentially be millions of documents, if the search is being done on the internet.

A number of methods have been reported for named entity extraction. Some of these methods utilize machine learning techniques to train models to extract common named entities from high-quality newswire text. They focus on the use of statistical models such as Hidden Markov Models, rule learning, and Maximum Entropy Markov Models, for a specific typical NE type. These studies learn the models or rules from a hand-tagged training corpus, so the models and rules are only effective on a similar corpus, and would perform poorly on other corpus with a different statistical characteristic or different genre or style. Due to the high cost of training models for each specific NE type, these approaches cannot fulfill the need of a general named entity extraction.

### BRIEF DESCRIPTION OF THE DRAWINGS

For a better understanding of the invention, embodiments will now be described, purely by way of example, with reference to the accompanying drawings, in which:

FIG. 1 shows a flow chart of a computer-implemented method of named entity extraction according to an embodiment

FIG. 2 shows a flowchart of a subroutine of the method of FIG. 1 according to an embodiment.

FIG. 3 shows an exemplary graphical representation of a named entity graph according to an embodiment.

FIG. 4. shows a block diagram of a computer system 400 upon which an embodiment may be implemented.

### DETAILED DESCRIPTION OF THE INVENTION

The following terms are used interchangeably through out the document including the accompanying drawings.

(a) “node” and “named entity”

(b) “document” and “electronic document”

Embodiments of the present invention provide methods, computer executable code and computer storage medium for extracting named entities (NE) from a document or a corpus of documents.

Embodiments of the present invention aim to perform an effective extraction of named entities on a low-quality corpus, and to extract any types of entities with minimum cost. The proposed method accommodates the diversity of documents (such as, in the organizational webpages), and is efficient to extract large numbers of named entities on a large-scale corpus. The embodiments effectively extract named entities from a large-scale document corpus where content redundancy is less distinct than the web-scale corpus.

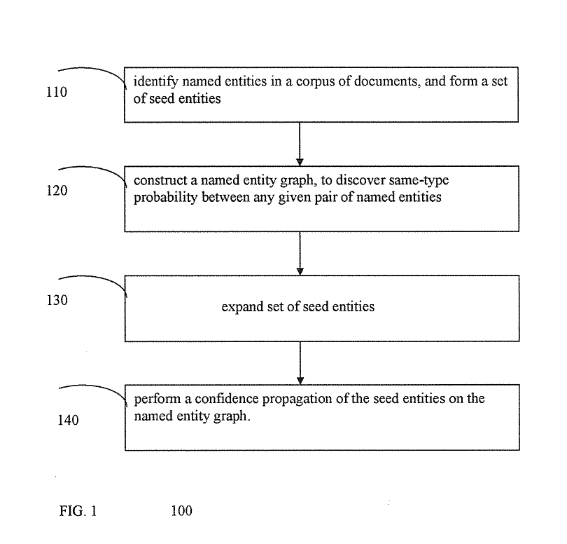

FIG. 1 shows a flow chart of a method 100 of extracting named entities according to an embodiment. The method 100 may be performed on a computer system (or a computer readable medium).

The method begins in step 110. In step 110, a document or a corpus of documents is accessed, and named entities (NE) appearing in the document or corpus of documents are identified, from which a set of seed entities can be formed manually or automatically using some existing resources.

The corpus of documents may be a collection of electronic documents, such as, but not limited to, a collection of web pages. The documents may be obtained from a repository, such as an electronic database. The electronic database may be an internal database, such as, an intranet of a company, or an external database, such as, Wikipedia. Also, the electronic database may be stored on a standalone personal computer, or spread across a number of computing machines, networked together, with a wired or wireless technology. For example, the electronic database may be hosted on a number of servers connected through a wide area network (WAN) or the internet.

In an embodiment, all possible named entities appearing in a corpus, such as, web pages in an intranet, are identified without concerning their types. The step identifies both simple and complex named entities. To illustrate, simple entities, such as, name of a person (“Jack Sparrow”) and location (“Bangkok”) may be identified. Complex named entities, such as product names (“Compaq Presario 3434 with HP Printer 4565”) and project names (“Entity Extraction Project in ABC Department”) may also be identified, regardless of their types.

In an embodiment, a collocation based method (such as, a method described by D. Downey et al. Locating complex named entities in web text. In Proc. of IJCAI, 2007), may be used to identify named entities. The present embodiment, however, uses a different method to determine the borders of named entities. It uses terms with numbers as the identifier of the named entity borders and a predefined threshold to select the candidates with Symmetric Conditional Probabilities (SCPs) above the threshold as the named entities.

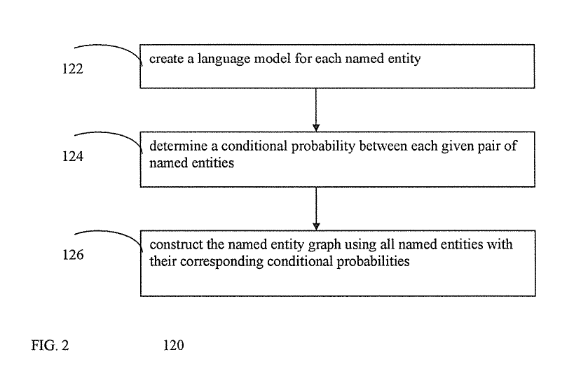

In step 120, a named entity graph is constructed to discover same-type probability between any given pair of named entities, identified in step 110 above. The method step involved in the construction of a named entity graph to discover same-type probability between any given pair of named entities include a number of sub-steps, as illustrated in FIG. 2. In an embodiment, a language model based graph construction method and a simhash based method is used to compute conditional probability between two named entities and construct a named entity graph that encodes the same-type information between named entities in a corpus of documents (such as, an organization's web pages). Both these models are described below.

Language Model Based Graph Construction

As is known, a graph is generally a collection of points where some points are connected by links. The points are called vertices (or nodes), and the links that connect some pairs of vertices are called edges. The edges may be directed or undirected. One of the main issues in graph construction is to compute the weight of each edge, which encodes the conditional probability of the end node being of the same type as the start node. In an embodiment, a three-stage method is proposed to compute the weight of an edge and construct a named entity graph: (a) create a language model for each named entity (node), (b) compute the conditional probability on the basis of KL-Divergence, and (c) construct the graph using all the named entities

In the first stage, a language model is created for each named entity (122). This is done by retrieving, for each named entity, the documents containing the named entity. The retrieved documents are then combined with snippets around the named entity, in the top ranked documents, into a virtual document. To illustrate, let us take a named entity, “Jack Sparrow”. Let us also assume that an entity search for “Jack Sparrow”, in a corpus of documents, yields a few hundred documents. In the present embodiment, the proposed method would combine the snippets around the named entity (“Jack Sparrow”), in the top ranked documents, into a virtual document. The top ranked documents could be titled, for example, “Pirate”, “Pirates of the Caribbean”, “Johnny Depp”, etc. And, the snippets could be “film”, “movie”, “actor”, “Hollywood”, etc.

The created virtual document reflects the diversity of the snippets where the named entity appears in, and captures the major characteristics of the contexts of the named entity in the snippets. Therefore, the virtual page collection serves as a good collection for building a language model for each named entity. In an embodiment, the language model is constructed using Dirichlet smoothing method.

In the second stage, conditional probability between each given pair of named entities is computed (124). In an embodiment, given a pair of entities, vᵢ and vⱼ, assuming the language models of vᵢ and vⱼ are Lᵢ and Lⱼ respectively, on the basis of their KL-Divergence D(Lⱼ|Lᵢ), the conditional probability may be computed as:

p(type(vⱼ)=cᵢ|type(vᵢ)=cᵢ)=e^{-D(L}^{ⱼ}^{|L}^{ᵢ}⁾

where type(vᵢ) is the type of the entity

The Kullback-Leibler (KL) divergence is a fundamental equation of information theory that quantifies the proximity of two probability distributions. KL-Divergence is always non-negative, and larger KL-Divergence means smaller conditional probability. When two language models are equal, the conditional probability has the largest value of 1 but the KL-Divergence has the smallest value of 0. As a result, the above equation is a good choice to transfer KL-Divergence into conditional probability.

In the third stage, the edges of a named entity (node) with other named entities (nodes) are established (126). This is done for each named entity. In an embodiment, a brute force method is used to establish the edges from a node to all the other nodes, and assign the corresponding conditional probability as its weight. Each node in the named entity graph is a named entity, and each edge reflects a conditional probability of an end node (named entity) being of same type as a start node (named entity).

Since a usage of such method may result in a complex graph which may prevent efficient computation, a threshold above an empirically selected threshold value is used and only edges with weights above this threshold are preserved.

Simhash Based Model for Accelerating Graph Construction

The selection of only those edges with a threshold value above a certain threshold results in a large amount of optimization. However, calculation of KL-Divergence values between a named entity (node) and the rest is a time-consuming process. To speed up this process, in an embodiment, the method uses simhash to compute the similarities of the virtual documents and filter out named entities (nodes) with lower similarities. The method is based on an observation: for three nodes (named entities) vᵢ, vⱼ and vₘ with virtual documents pᵢ, pⱼ and pₘ, let the simhash codes of these virtual pages be shᵢ, shⱼ and shₘ respectively. If the similarity of pₘ and pᵢ is less than that of pₘ and pⱼ, i.e., the Hamming distance between shₘ and shᵢ is much larger than that of between shₘ and shⱼ, the KL-Divergence from vₘ to vᵢ tends to be larger than that from vₘ to vⱼ, and the conditional probability from vₘ to vᵢ tends to be smaller than that from vₘ and vⱼ. The simhash is used to estimate the conditional probability in order to filter out low weight edges in the entity graph, and only compute the weight of the edges between similar nodes.

In an embodiment, a 64-bit simhash code is generated for each entity (node) based on its virtual document. Next, for each node, the Hamming distances between its simhash code and the simhash codes of all the other nodes is computed, and the nodes with Hamming distances more than a predefined threshold are filtered out. Finally, a language model based method is used to compute the weights of the edges between a node and the remaining nodes.

In step 130, the seed entities set is expanded to include some related non-seed entities.

In step 140, a confidence propagation of the seed entities on the named entity graph is performed to predict whether the confidence values of non-seed entities are of the target type. The proposed method proposes a novel algorithm to perform confidence propagation.

Given the expanded seed set S={(s₁, c₁), . . . , (sᵢ, cᵢ), . . . , (sₙ, cₙ)}, where sᵢ and cᵢ are the index and confidence of the ith seed in V respectively, and the constructed named entity graph G=<V, E> with the transition matrix T where

$$T ( {v}_{i} , {v}_{j} ) = \{ \begin{matrix}w ( j , i ) / {\sum }_{k = 1}^{n} w ( j , k ) , & if ( {v}_{j} , {v}_{i} ) ∈ G \\ 0 , & otherwise\end{matrix}$$

The following algorithm may be used to perform confidence propagation.

Algorithm 1 The named entity confidence propagation algorithm

Input: Decay factor α_{B}, number of iterations M_{B}, expanded seed set S,
and the named entity graph transition matrix T.
Output: Named entity confidence vector t*.
//generate seed confidence vector
1: d = 0_{|v|};
2: for each (s₁, c₁) [symbol] in S do
3: d(sᵢ) = cᵢ ; [symbol]
4: end for
//normalize seed confidence vector
5: d = d/Σ₁₌₁^{|v|} d(j) ; [symbol]
//perform confidence propagation
6: t* = d :
7: for i = 1 to M_{B} do
8: t* = α_{B}.T.t* + (1 − α_{B}). d ;
9: end for [symbol]
indicates data missing or illegible when filed

A confidence value Confᵢ for ∀vᵢεV is obtained after confidence propagation. Its probability of being the target type c* is measured using:

$$p ( type ( {v}_{i} ) = {c}^{*} ) = \frac{{Conf}_{i}}{{max}_{i} ( {Conf}_{i} )}$$

Depending upon the probability of each named entity, a predefined threshold may be used to determine whether it's of the target type.

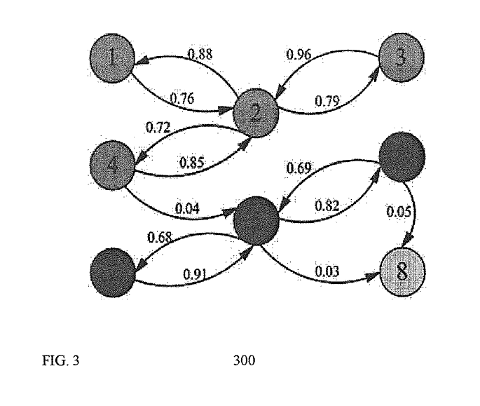

FIG. 3 shows an exemplary graphical representation of a named entity graph according to an embodiment.

The named entity graph 300 consists of eight entities. The eight entities are divided into three types marked with different shades of a color. The conditional probability between a given pair of named entities (nodes) is also shown. On this graph, given an expanded seed set S={(1, 1.0), (4, 0.85)}, and setting α_{B}=0.85, and M_{B}=60, the above described confidence propagation may be invoked to compute the named entity confidence vector

t*=(0.217,0.4346,0.1223,0.1801,0.0024,0.0011,0.0009,0.0001)

and the probability vector

p=(0.499,1,0.281,0.414,0.006,0.003,0.002,0.0002)

Using any threshold value between 0.006 and 0.281, the proposed method would be able to identify that the first four nodes are of the target type.

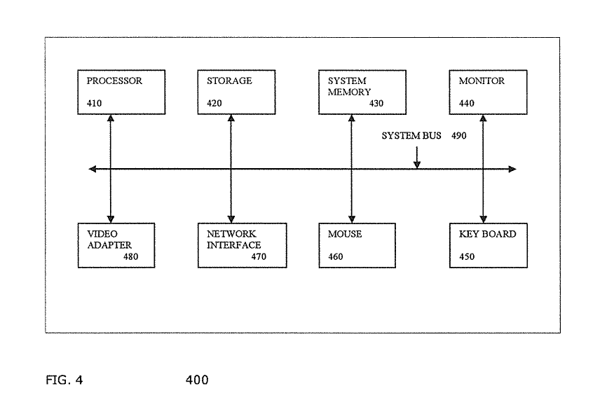

FIG. 4. shows a block diagram of a computer system 400 upon which an embodiment may be implemented. The computer system 400 includes a processor 410, a storage medium 420, a system memory 430, a monitor 440, a keyboard 450, a mouse 460, a network interface 420 and a video adapter 480. These components are coupled together through a system bus 490.

The storage medium 420 (such as a hard disk) stores a number of programs including an operating system, application programs and other program modules. A user may enter commands and information into the computer system 400 through input devices, such as a keyboard 450, a touch pad (not shown) and a mouse 460. The monitor 440 is used to display textual and graphical information.

An operating system runs on processor 410 and is used to coordinate and provide control of various components within personal computer system 400 in FIG. 4. Further, a computer program may be used on the computer system 400 to implement the various embodiments described above.

It would be appreciated that the hardware components depicted in FIG. 4 are for the purpose of illustration only and the actual components may vary depending on the computing device deployed for implementation of the present invention.

Further, the computer system 400 may be, for example, a desktop computer, a server computer, a laptop computer, or a wireless device such as a mobile phone, a personal digital assistant (PDA), a hand-held computer, etc.

The embodiment described provides an effective way of extracting named entities given a corpus of documents. Embodiments address the problem of extracting any types of entities from a general organization's web pages with minimum cost. The proposed weighted named entity graph is capable of encoding the complex relationships between the types of each named entity and others, so the propagation of seed confidences on the graph can make up the lack of the web-scale redundancy, and can support effective organization-scale extraction. Further, the confidence propagation on the named entity graph can be transformed to efficient matrix computation, which can support efficient extraction on a large-scale corpus.

It will be appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A computer-implemented method of extracting a named entity, comprising:
identifying named entities in a corpus of documents, and forming a set of seed entities manually or automatically using some existing resources;
constructing a named entity graph, to discover same-type probability between any given pair of named entities;
expanding the set of seed entities; and
performing a confidence propagation of the seed entities on the named entity graph.

2. A method according to claim 1, wherein each node in the named entity graph is a named entity, and each edge reflects a conditional probability of an end node (named entity) being of same type as a start node (named entity).

3. A method according to claim 1, wherein the construction of a named entity graph comprises:
creating a language model for each named entity;
determining a conditional probability between each given pair of named entities, with each named entity having its own language model; and
constructing the named entity graph using all named entities with their corresponding conditional probabilities.

4. A method according to claim 3, wherein the determination of a conditional probability between each given pair of named entities is based on their KL-Divergence.

5. A method according to claim 3, further comprising, prior to the graph construction, the steps of:
determining, for each named entity, edges between the named entity and rest of the named entities; and
determining conditional probability for each edge between the named entity and the rest of the named entities.

6. A method according to claim 5, wherein only edges with the conditional probability above a pre-determined threshold value are used for constructing the graph.

7. A method according to claim 5, further comprising using a simhash to filter out edges with conditional probability below a pre-determined threshold value.

8. A method according to claim 1, wherein the confidence propagation results in obtaining a confidence value and a probability value for a target entity.

9. A method according to claim 8, wherein a predetermined threshold probability value is used to determine whether the target entity is a named entity.

10. A method according to claim 1, wherein the named entities are identified by a collocation-based identification method.

11. A method according to claim 1, wherein the corpus of documents is obtained from a repository.

12. A method according to claim 1, wherein the repository is an organizational database.

13. A system, comprising:
a processor; and
a memory coupled to the processor, wherein the memory includes instructions for:
identifying named entities in a corpus of documents, to form a set of seed entities;
constructing a named entity graph, to discover same-type probability between any given pair of named entities;
expanding the set of seed entities; and
performing a confidence propagation of the seed entities on the named entity graph.

14. A computer program comprising computer program means adapted to perform all of the steps of claim 1 when said program is run on a computer.

15. A computer program according to claim 14 embodied on a computer readable medium.
